(19) United States
(12) Patent Application Publication
(10) Pub. No.: US 2006/0140617 A1
(43) Pub. Date: Jun. 29, 2006

(54) Integrated display and image sensing module

(75) Inventors: Wei-Chu Xu, Shenzhen (CN); Che-Kuei Mai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/318,219

(22) Filed: Dec. 23, 2005

(30) Foreign Application Priority Data
Dec. 24, 2004 (TW) 93140429

(51) Int. Cl. G03B 7/099

(52) U.S. Cl. 396/268; 396/287

(57) ABSTRACT

An integrated display and image sensing module (20) includes a liquid crystal panel (200), an image sensing device (206) and a sensing control IC (207). The image sensing device and the sensing control IC are disposed on the liquid crystal panel. The sensing control IC receives the image data from the image sensing device and directly controls the liquid crystal panel to display corresponding images.

### BACKGROUND

1. Field of the Invention

The present invention relates to an integrated display and image sensing module, and in particular to such a module having a display panel with an image sensing device mounted thereon.

2. General Background

With continuing advances in electronics technology, digital camera modules have now become one of the standard features of many electronic handsets such as mobile phones and Personal Digital Assistants (PDAs). The digital camera modules are usually required to have compact profiles commensurate with the profiles of the handsets in which they are housed.

Conventional camera integrated handsets basically include a printed circuit board (PCB), a liquid crystal display (LCD), and a digital camera module. The LCD and digital camera module are both disposed on the PCB and electrically connected thereto. The digital camera module includes an image sensor and several electronic components. When taking photos, light sensed by the image sensor is converted into electrical signals, and the corresponding electrical image data are transferred to the electronic components, the LCD or other modules through the PCB for further processing and use.

In conventional camera integrated handsets, an additional PCB is needed to transfer the electrical image data produced by the image sensor to the LCD or to other modules. The extra PCB adds to a thickness of the handset, and thus the profile of the handset may not be able to meet stringent end user requirements. Hence, there is a need for a display and an image sensing module that are thin enough for use in compact handsets.

### SUMMARY

A preferred embodiment of an integrated display and image sensing module includes a liquid crystal panel, an image sensing device and a sensing control integrated circuit (IC). The image sensing device and the sensing control IC are disposed on the liquid crystal panel. The image sensing device converts light into electrical image data and the sensing control IC receives the image data from the image sensing device and directly controls the liquid crystal panel to display corresponding images.

Moreover, the integrated display and image sensing module includes a driver IC disposed on the liquid crystal panel and a flexible printed circuit board electrically connected to the liquid crystal panel and the driver IC. The driver IC drives the liquid crystal panel to display image according to external data transmitted through the flexible printed circuit board from a control unit of a mobile phone or other handsets.

The above-described integrated display and image sensing module is suitable for thin-profile handsets and other kinds of mobile devices. Image data produced by the image sensing device can be transferred to the sensing control IC directly through the transparent wirings on the liquid crystal panel because the image sensing device and other ICs thereof are directly mounted on the liquid crystal panel without any additional PCB. Thus, the thickness of the integrated display and image sensing modules in the embodiments of the invention can be reduced and meets the requirement of compact profile for handsets or mobile devices.

Other advantages and novel features will become more apparent from the following detailed description when taken in conjunction with the accompanying drawings.

### BRIEF DESCRIPTION OF THE DRAWINGS

Embodiments of the present invention can be more fully understood by reading the subsequent detailed description and examples with references made to the accompanying drawings, wherein:

FIG. 1 is a schematic top view of an integrated display and image sensing module in accordance with a first embodiment of the invention;

FIG. 2 is a side view of the integrated display and image sensing module shown in FIG. 1;

FIG. 3 is a schematic top view of an integrated display and image sensing module in accordance with a second embodiment of the invention; and

FIG. 4 is a side view of the integrated display and image sensing module shown in FIG. 3.

### DETAILED DESCRIPTION OF PREFERRED EMBODIMENTS

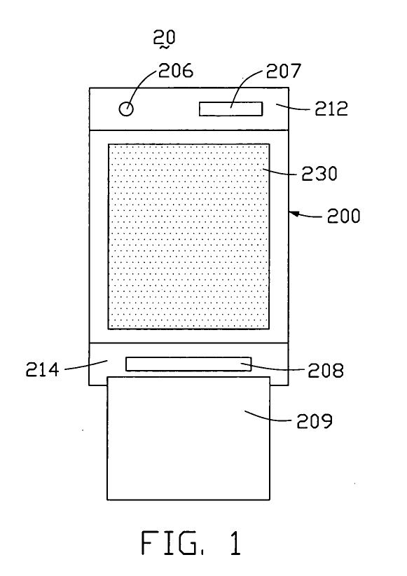

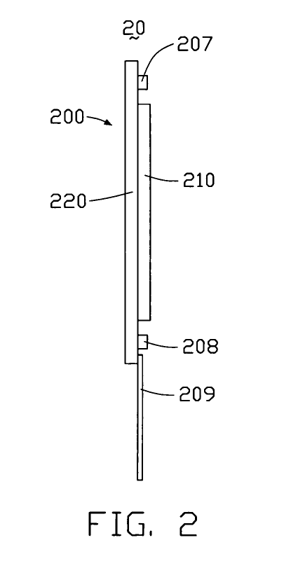

FIGS. 1 and 2 are schematic top and side views of an integrated display and image sensing module in accordance with a first embodiment of the invention. The integrated display and image sensing module 20 includes a liquid crystal panel 200, an image sensing device 206, and a sensing control IC 207.

In the illustrated embodiment, the liquid crystal panel 200 includes two opposite overlapping glass substrates 210, 220, with liquid crystal sealed therebetween. The glass substrate 220 is larger than the glass substrate 210. In particular, the glass substrate 220 protrudes from two edges of the glass substrate 210, thereby defining two extending end portions 212, 214. In the illustrated embodiment, the extending end portions 212, 214 are located at two opposite top and bottom ends of the glass substrate 210 respectively. However, in other embodiments, the extending end portions 212, 214 may protrude from any two selected ends or sides of the glass substrate 210. The glass substrates 210, 220 cooperatively define a display area 230 and two peripheral circuit areas. The display area 230 is defined in a central portion of an area where the glass substrates 210, 220 overlap. The peripheral circuit areas are separately defined at the two extending end portions 212, 214 of the glass substrate 220.

The image sensing device 206 and the sensing control IC 207 are disposed on the peripheral circuit area of the extending end portion 212, and are electrically connected to transparent wirings on the extending end portion 212 of the glass substrate 220. The image sensing device 206 includes an assembly of a lens set, such as a conventional Nikkor® lens set, and a image sensor, such as a charge coupled device (CCD), and is mounted on the extending end portion 212 of the glass substrate 220 by way of an anisotropic conductive film (ACF) or silver paste. Light sensed by the image sensing device 206 is converted into electrical signals. The sensing control IC 207 then controls the liquid crystal panel 200 to display images according to electrical image data received from the image sensing device 206, via the transparent wirings on the glass substrate 220.

The integrated display and image sensing module 20 of the first embodiment further includes an LCD driver IC 208 and a flexible printed circuit board (FPCB) 209. The LCD driver IC 208 is disposed on the other peripheral circuit area that is at the extending end portion 214, and is electrically connected to the transparent wirings on the glass substrate 220. The FPCB 209 is a film/copper-foil laminated board. The FPCB 209 comprises a plurality of wirings contacting electrodes on the extending end portion 214 of the glass substrate 220, and is electrically connected to the LCD driver IC 208 through transparent wirings on the extending end portion 214. Moreover, the FPCB 209 is utilized as a connector between the integrated display and image sensing module 20 and other components or modules on the main board of an associated handset or mobile device such as a PDA or a mobile phone. Thus the LCD driver IC 208 can control the liquid crystal panel 200 to display images according to data received from the other components or modules on the main board via the flexible printed circuit board 209.

The sensing control IC 207 and the LCD driver IC 208 are directly mounted on the liquid crystal panel 200 by a Chip on Glass (COG) package process, because the sensing control IC 207 and the LCD driver IC 208 cannot be directly fabricated on the glass substrate 220. In particular, the bare silicon dies of the sensing control IC 208 and the LCD driver IC 209 are inverted, and then mounted on the glass substrate 220 by ACF or silver paste. Thereby, the sensing control IC 208 and the LCD driver IC 209 are electrically connected to the transparent wirings on the extending end portions 212, 214 of the glass substrate 220.

Accordingly, when taking photos, image data produced by the image sensing device 206 are transferred to the sensing control IC 207 directly through the transparent wirings on the liquid crystal panel 200 without the need for any additional printed circuit board. Thus the thickness of the integrated display and image sensing module 20 is reduced. Accordingly, the integrated display and image sensing module 20 can meet stringent requirements for associated handsets or mobile devices to have a compact profile.

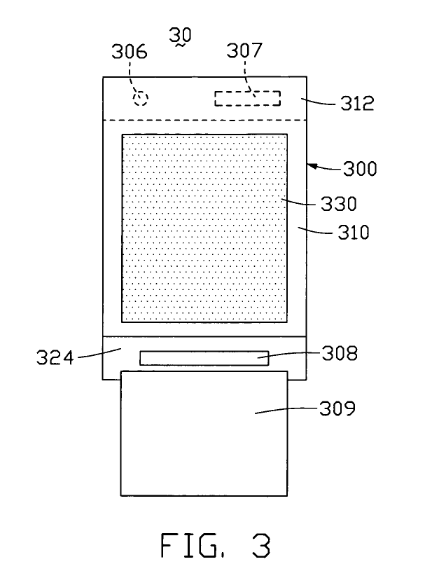

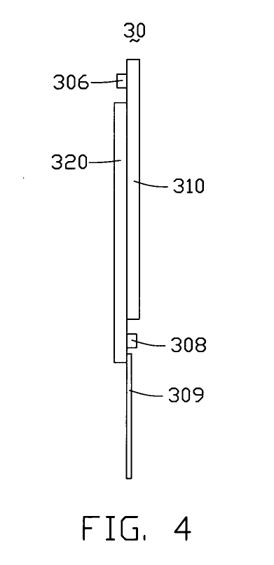

FIGS. 3 and 4 are schematic top and side views of an integrated display and image sensing module in accordance with a second embodiment of the invention. The integrated display and image sensing module 30 includes a liquid crystal panel 300, an image sensing device 306, a sensing control IC 307, and an LCD driver IC 308. An FPCB 309 is electrically connected to transparent wirings on the glass substrate 320. The FPCB 309 is utilized as a connector between the integrated display and image sensing module 30 and other components or modules on a main board of an associated handset or mobile device.

As shown in FIGS. 3 and 4, the structure of the liquid crystal panel 300 is different from that of the liquid crystal panel 200 of the first embodiment. First and second glass substrates 310, 320 of the liquid crystal panel 300 abut each other but are offset from each other, thereby defining a first extending portion 312 of the first glass substrate 310 and a second extending portion 324 of the second glass substrate 320. The glass substrates 310, 320 cooperatively define a display area 330 and two peripheral circuit areas. The display area 330 is defined in a central portion of an area where the glass substrates 310, 320 overlap. The peripheral circuit areas are separately defined at the two extending end portions 312, 324 of the glass substrates 310, 320.

The image sensing device 306, the sensing control IC 307, and the LCD driver IC 308 are all mounted on the extending end portions 312, 324 of the glass substrates 310, 320 by way of an ACF or silver paste, in similar fashion to that described above in relation to the first embodiment. The image sensing device 306 and the sensing control IC 307 are disposed on the first end portion 312 at a bottom side of the liquid crystal panel 300, and the LCD driver IC 308 is disposed on the second end portion 324 at a top side of the liquid crystal panel 300. With this configuration, the integrated display and image sensing module 30 is suitable for certain kinds of associated handsets or mobile devices having corresponding configurations.

Moreover, in alternative embodiments, the arrangement of the image sensing device and the other components is not limited to the locations described above in relation to the first and second embodiments. Other arrangements can be practiced. For example, a first glass substrate can protrude from a second glass substrate at one side thereof only, thereby defining a single extending end portion. The image sensing device, the sensing control IC, the driver IC, and the flexible printed circuit board can all be disposed at the extending end portion. This configuration can enable the layout of the transparent wirings of the glass substrates to be simplified. Accordingly, process of fabrication of the integrated display and image sensing module can be simplified.

In summary, an integrated display and image sensing module for handsets or mobile devices is provided. Image data produced by the image sensing device can be transferred to the sensing control IC directly through the transparent wirings on the liquid crystal panel, because the image sensing device and associated ICs are directly mounted on the liquid crystal panel without having any additional PCB. Thus, the thickness of the integrated display and image sensing module can be reduced, and can meet the requirement for associated handsets or mobile devices to have a compact profile.

While the invention has been described by way of example and in terms of the preferred embodiments, it is to be understood that the invention is not limited thereto. To the contrary, various modifications and similar arrangements as would be apparent to those skilled in the art are intended to be covered by the above description. Therefore, the scope of the appended claims should be accorded the broadest interpretation so as to encompass all such modifications and similar arrangements.

We claim:

1. An integrated display and image sensing module, comprising:
a liquid crystal panel;
an image sensing device disposed on the liquid crystal panel, for converting light into electrical image data; and
a sensing control integrated circuit (IC) disposed on the liquid crystal panel, for receiving the image data and controlling the liquid crystal panel to display corresponding images.

2. The integrated display and image sensing module as claimed in claim 1, further comprising:
a driver IC disposed on the liquid crystal panel; and
a flexible printed circuit board electrically connected to the liquid crystal panel and the driver IC, wherein the driver IC is for driving the liquid crystal panel to display images according to external data transmitted through the flexible printed circuit board.

3. The integrated display and image sensing module as claimed in claim 2, wherein the liquid crystal panel includes two overlapping substrates.

4. The integrated display and image sensing module as claimed in claim 3, wherein the substrates are made of glass.

5. The integrated display and image sensing module as claimed in claim 4, wherein a first one of the substrates protrudes from a second one of the substrates at one side, thereby defining an extending end portion of the first substrate.

6. The integrated display and image sensing module as claimed in claim 5, wherein the image sensing device, the sensing control IC, the driver IC, and the flexible printed circuit board are disposed on the extending end portion of the first substrate.

7. The integrated display and image sensing module as claimed in claim 4, wherein a first one of the substrates protrudes from a second one of the substrates at two sides of the second substrate, thereby defining two extending end portions of the first substrate.

8. The integrated display and image sensing module as claimed in claim 7, wherein the image sensing device and the sensing control IC are disposed on a first one of the end portions, and the driver IC and the flexible printed circuit board are disposed on a second one of the end portions.

9. The integrated display and image sensing module as claimed in claim 4, wherein the substrates are offset from each other, thereby defining a first extending end portion of a first one of the substrates and a second extending end portion of a second one of the substrates.

10. The integrated display and image sensing module as claimed in claim 9, wherein the image sensing device and the sensing control IC are disposed on the first end portion, and the driver IC and the flexible printed circuit board are disposed on the second end portion.

11. The integrated display and image sensing module as claimed in claim 2, wherein the flexible printed circuit board is a film/copper-foil laminated board.
